(19) United States
(12) Patent Application Publication
(10) Pub. No.: US 2025/0192233 A1
(43) Pub. Date: Jun. 12, 2025

(54) ORGANOSULFUR-BASED ELECTROLYTES FOR BATTERIES THAT CYCLE LITHIUM IONS AND BATTERIES INCLUDING THE SAME

(71) Applicants: GM Global Technology Operations LLC, Detroit, MI (US); UChicago Argonne, LLC, Chicago, IL (US)

(72) Inventors: Meinan HE, Birmingham, MI (US); Hasnain Hafiz, Troy, MI (US); Louis G. Hector, JR., Shelby township, MI (US); Chi-Cheung Su, Westmont, IL (US); Michael Dato, Chicago, IL (US); Khalil Amine, Oakbrook, IL (US)

(21) Appl. No.: 18/530,818

(22) Filed: Dec. 6, 2023

(51) Int. Cl. H01M 10/0569; H01M 4/02; H01M 4/62; H01M 10/0525; H01M 10/0567

(52) U.S. Cl. CPC H01M 10/0569; H01M 4/62; H01M 10/0525; H01M 10/0567; H01M 2004/028; H01M 2220/20

(57) ABSTRACT

A battery that cycles lithium ions includes a negative electrode, a positive electrode spaced apart from the negative electrode, and an electrolyte infiltrating the positive electrode. The positive electrode includes a high-voltage positive electrode material. The electrolyte includes an organosulfur compound, a fluorinated aromatic co-solvent, a solid electrolyte interphase (SEI) former, and at least one lithium salt.

### GOVERNMENT FUNDING

This invention was made with Government support under Agreement No. DOE-OSE9644 awarded by the U.S. Department of Energy. The Government may have certain rights in the invention.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to electrolytes for batteries that cycle lithium ions, and more particularly to organosulfur-based electrolytes.

Batteries that cycle lithium ions generally include a positive electrode, a negative electrode spaced apart from the positive electrode, and an ionically conductive electrolyte that provides a medium for the conduction of lithium ions between the positive and negative electrodes during discharge and charge of the batteries. The electrolyte may be formulated to exhibit certain desirable properties including high ionic conductivity, high dielectric constant (correlated with a high ability to dissolve salts), good thermal stability, a wide electrochemical stability window, ability to form a stable ionically conductive solid electrolyte interphase on the surface of the positive electrode and/or the negative electrode, and chemical compatibility with other components of the batteries.

### SUMMARY

A battery that cycles lithium ions, according to one or more embodiments of the present disclosure, comprises a negative electrode, a positive electrode spaced apart from the negative electrode, and an electrolyte infiltrating the positive electrode. The negative electrode comprises an electroactive negative electrode material. The positive electrode comprises a high-voltage positive electrode material. The electrolyte comprises an organosulfur compound, a fluorinated aromatic co-solvent, a solid electrolyte interphase (SEI) former, and at least one lithium salt.

The fluorinated aromatic co-solvent may comprise a fluoroalkyl-substituted benzene, a fluoroalkoxy-substituted benzene, or a combination thereof.

In embodiments, the fluorinated aromatic co-solvent may comprise an aromatic hydrocarbon represented by formula (3):

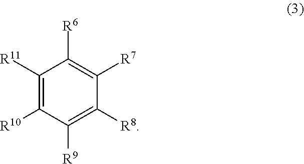

In formula (3), R⁶, R⁷, R⁸, R⁹, R¹⁰, and R¹¹ each individually may be H, halogen, alkyl, alkenyl, alkynyl, aryl, alkoxy, alkenoxy, alkynoxy, aryloxy, heterocyclyloxy, alkyl-heterocyclyloxy, hydroxyl, carboxyl, ester, or ether, and at least one of R⁶, R⁷, R⁸, R⁹, R¹⁰, and R¹¹ is a fluoroalkyl or a fluoroalkoxy. The fluoroalkyl may have the formula —CₙHₓF_{y} or —CH₂CₙHₓF_{y}. The fluoroalkoxy may have the formula —CH₂OCₙHₓF_{y} or —CF₂OCₙHₓF_{y}, where n is an integer from 1 to 5, x is an integer from 0 to 11, y is an integer from 1 to 11, and the sum of x and y is 2n+1.

The fluorinated aromatic co-solvent may constitute, by volume, greater than or equal to 10% and less than or equal to 90% of the electrolyte.

In embodiments, the organosulfur compound may comprise an acyclic sulfoxide represented by formula (1):

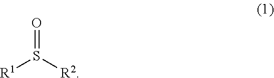

In formula (1), R¹ and R² each individually may be H; halogen; an unsubstituted or fluorinated alkyl, alkenyl, alkynyl, silyl, siloxy, aryl, aralkyl, heterocyclyl, heterocyclylalkyl, cycloalkyl, or cycloalkylalkyl; —OR³; —C(O)R³; —C(O)OR³; or —OC(O)R³. In formula (1), R³ may be H or an unsubstituted or fluorinated alkyl, alkenyl, alkynyl, aryl, aralkyl, or heterocyclyl.

In embodiments, the organosulfur compound may comprise a cyclic or acyclic sulfone represented by formula (2):

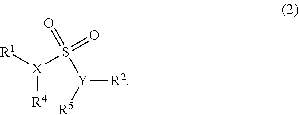

In formula (2), R¹ and R² each individually may be H; halogen; an unsubstituted or fluorinated alkyl, alkenyl, alkynyl, silyl, siloxy, aryl, aralkyl, heterocyclyl, heterocyclylalkyl, cycloalkyl, or cycloalkylalkyl; —OR³; —C(O)R³; —C(O)OR³; or —OC(O)R³. In formula (2), R⁴ and R⁵ each individually may be H; halogen; an unsubstituted or fluorinated alkyl, alkenyl, alkynyl, silyl, siloxy, aryl, aralkyl, heterocyclyl, heterocyclylalkyl, cycloalkyl, or cycloalkylalkyl; —OR³; —C(O)R³; —C(O)OR³; or —OC(O)R³; or R⁴ and R⁵ may together form a 5 or 6 membered substituted or unsubstituted heterocyclic ring including the sulfur (S) atom. In formula (2), X and Y each individually may be —C(R³)—, —O—, or —N—. In formula (2), R³ may be H or an unsubstituted or fluorinated alkyl, alkenyl, alkynyl, aryl, aralkyl, or heterocyclyl.

In embodiments, the organosulfur compound may comprise an acyclic sulfone selected from the group consisting of ethyl methyl sulfone (EMS), dimethylmethanesulfonamide (DMMA), methyl isopropyl sulfone (MIS), dimethyl sulfate (DMS), methyl methanesulfonate (MMS), and methanesulfonyl fluoride (MSF).

In embodiments, the organosulfur compound may comprise a cyclic sulfone selected from the group consisting of sulfolane and 1,3-propane sultone.

The organosulfur compound may constitute, by volume, greater than or equal to 10% and less than or equal to 90% of the electrolyte.

The SEI former may comprise a cyclic carbonate selected from the group consisting of ethylene carbonate (EC), fluoroethylene carbonate (FEC), vinylene carbonate (VC), and vinyl ethylene carbonate (VEC).

The SEI former may constitute, by volume, greater than or equal to 5% and less than or equal to 50% of the electrolyte.

The at least one lithium salt may comprise lithium hexafluorophosphate (LiPF₆), lithium bis(fluorosulfonyl)imide (LiFSI), lithium bis(trifluoromethanesulfonyl)imide (LiTFSI), or a combination thereof.

The at least one lithium salt may be present in the electrolyte at a concentration of greater than or equal to 0.5 Molar and less than or equal to 2 Molar.

The electrolyte may be substantially free of acyclic hydrofluoroethers.

The electroactive negative electrode material may comprise graphite, silicon, silicon oxide, or an elemental lithium metal film.

A battery that cycles lithium ions, in accordance with one or more embodiments of the present disclosure, comprises a negative electrode, a positive electrode spaced apart from the negative electrode, and an organosulfur-based electrolyte infiltrating the negative electrode and the positive electrode. The negative electrode comprises an electroactive negative electrode material comprising graphite. The positive electrode comprises a high-voltage positive electrode material.

The organosulfur-based electrolyte comprises an organosulfur compound, a fluorinated aromatic co-solvent, a solid electrolyte interphase (SEI) former, and a lithium salt. The organosulfur compound comprises an acyclic sulfoxide, an acyclic sulfone, a cyclic sulfone, or a combination thereof. The fluorinated aromatic co-solvent comprises a fluoroalkyl-substituted benzene, a fluoroalkoxy-substituted benzene, or a combination thereof,

The organosulfur compound may constitute, by volume, greater than or equal to 10% and less than or equal to 90% of the organosulfur-based electrolyte.

The fluorinated aromatic co-solvent may constitute, by volume, greater than or equal to 10% and less than or equal to 90% of the organosulfur-based electrolyte.

The SEI former may comprise a cyclic carbonate selected from the group consisting of ethylene carbonate (EC), fluoroethylene carbonate (FEC), vinylene carbonate (VC), and vinyl ethylene carbonate (VEC).

The SEI former may constitute, by volume, greater than or equal to 5% and less than or equal to 50% of the organosulfur-based electrolyte.

The lithium salt may comprise lithium hexafluorophosphate (LiPF₆), lithium bis(fluorosulfonyl)imide (LiFSI), lithium bis(trifluoromethanesulfonyl)imide (LiTFSI), or a combination thereof.

The lithium salt may be present in the organosulfur-based electrolyte at a concentration of greater than or equal to 0.5 Molar and less than or equal to 2 Molar.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by a battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a positive electrode, a negative electrode, a separator, and an electrolyte infiltrating the positive and negative electrodes and the separator.

In the drawings, reference numbers may be reused to identify similar and/or identical elements.

### DETAILED DESCRIPTION

### Definitions

“Alkyl” means a univalent linear or branched saturated hydrocarbon moiety, consisting solely of carbon and hydrogen atoms, and having from 1 to 20 carbon atoms, optionally from 1 to 6 carbon atoms. Alkyls are formed by removing one hydrogen atom from an alkane and have the formula: —CₙH₂ₙ₊₁, where n is an integer ranging from 1 to 20, optionally from 1 to 6. Alkyls having 1 to 6 carbon atoms may be referred to as C₁-C₆ alkyls. Examples of alkyls include, methyl, ethyl, propyl, isopropyl, isobutyl, sec-butyl, tert-butyl, pentyl, n-hexyl, octyl, and dodecyl. An alkoxy is a univalent moiety having the formula —O—R, where R is an alkyl.

“Alkylene” means a divalent linear or branched, saturated hydrocarbon moiety having from 2 to 20 carbon atoms, optionally from 2 to 5 carbon atoms. Example alkylene moieties include methylene, ethylene, propylene, butylene, and pentylene.

“Alkenyl” means a univalent linear or branched hydrocarbon moiety of 2 to 20 carbon atoms, or optionally from 3 to 5 carbon atoms and including at least one carbon-carbon double bond (C═C). Example alkenyls include vinyl, allyl, ethenyl, propenyl, isopropenyl, ethylidene, and isopropylidene. An alkenoxy is a univalent moiety having the formula —O—R, where R is an alkenyl.

“Alkynyl” means a univalent linear or branched hydrocarbon moiety of 2 to 20 carbon atoms, or optionally from 3 to 5 carbon atoms and including at least one carbon-carbon triple bond (C≡C). An alkynoxy is a univalent moiety having the formula —O—R, where R is an alkynyl.

“Aryl” means a univalent cyclic aromatic hydrocarbon moiety consisting of a monocyclic, bicyclic, or tricyclic aromatic ring containing from 6 to 14 carbon ring atoms. Examples of aryls include phenyl, naphthyl, benzyl, benzylidene, styryl, phenethyl, cinnamyl, and benzhydryl. An aryloxy is a univalent moiety having the formula —O—R, where R is an aryl.

“Aralkyl” means a univalent hydrocarbon moiety derived from an alkyl by replacing one or more of the hydrogen atoms with aryl moieties.

“Cycloalkyl” means a univalent saturated hydrocarbon moiety derived from a cycloalkane by removal of a hydrogen atom from a ring carbon. Cycloalkyls have the general formula —CₙH₂ₙ₋₁. Examples of cycloalkyls include cyclopropyl, cyclobutyl, cyclopentyl, cyclohexyl, and cycloheptyl.

“Cycloalkylalkyl” means a univalent hydrocarbon moiety derived from an alkyl by replacing one or more of the hydrogen atoms with a cycloalkyl. Cycloalkylalkyl moieties have the formula —R—R′, where R is an alkylene and R′ is a cycloalkyl.

“Fluorinated” refers to a hydrocarbon moiety in which one or more hydrogen atoms in the moiety are replaced or substituted with fluorine atoms. A fluorinated alkyl may be referred to as a “fluoroalkyl” and a fluorinated alkoxy may be referred to as a “fluoroalkoxy”.

“Heterocyclyl” means a univalent hydrocarbon moiety formed by removing a hydrogen atom from any ring atom of a heterocyclic compound, i.e., a cyclic compound having rings containing carbon atoms and at least one heteroatom selected from N, O, or S. A heterocyclyloxy is a univalent hydrocarbon moiety having the formula —O—R, where R is a heterocyclyl.

“Alkyl-heterocyclyl” means a univalent hydrocarbon moiety derived from an alkyl by replacing one or more of the hydrogen atoms with a heterocyclyl. Alkyl-heterocyclyl moieties are represented by the formula —R—R′, where R is an alkylene and R′ is a heterocyclyl. An alkyl-heterocyclyloxy is a univalent hydrocarbon moiety having the formula —O—R″, where R″ is an alkyl-heterocyclyl.

“Silyl” means a moiety having the formula —Si(R)₃, where R is a hydrocarbon moiety, e.g., an alkyl, alkenyl, alkynyl, or cycloalkyl.

“Siloxy” means a moiety having the formula —OSi(R)₃, where R is a hydrocarbon moiety, e.g., an alkyl, alkenyl, alkynyl, or cycloalkyl.

“Substituted” refers to a compound or moiety in which a hydrogen atom of the compound or moiety is replaced or substituted with a fluorinated or unfluorinated hydrocarbon moiety, e.g., alkyl, alkenyl, alkynyl, aryl, aralkyl, or heterocyclyl.

Expressions such as “at least one of A, B, and C” should be construed to mean a logical (A OR B OR C), using a non-exclusive logical OR, and should not be construed to mean “at least one of A, at least one of B, and at least one of C.”

The term “and/or” includes combinations of one or more of the associated listed items.

The singular forms “a,” “an,” and “the” may be intended to include the plural forms as well, unless the context clearly indicates otherwise.

The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps.

The terms “composition” and “material” are used interchangeably to refer broadly to a substance containing at least the preferred chemical constituents, elements, or compounds, but which may also comprise additional elements, compounds, or substances, including trace amounts of impurities (i.e., in amounts less than or equal to 0.1%). An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

The term “metal” may refer to a pure elemental metal or to an elemental metal and one or more other metal or nonmetal elements. The term “elemental metal” means that the relevant metal is present in its purest form and does not contain any other elements, except in trace amounts, i.e., as impurities.

### Embodiments

The presently disclosed organosulfur-based electrolytes are formulated for use in batteries that cycle lithium ions and may operate at relatively high voltages, e.g., greater than 4.5 Volts versus Li⁺/Li. The organosulfur-based electrolytes comprise an organosulfur compound, a fluorinated aromatic co-solvent, and at least one lithium salt. The organosulfur compound is formulated to solvate the lithium salt and has a wide electrochemical stability window, which may provide the battery with improved high-voltage cycling stability, as compared to batteries that include carbonate-based electrolytes. The fluorinated aromatic co-solvent is formulated to help improve the ionic conductivity of the organosulfur-based electrolyte, for example, by reducing the viscosity and increasing the polarity thereof, as compared to organosulfur-based electrolytes that do not comprise a fluorinated aromatic co-solvent and as compared to organosulfur-based electrolytes that comprise fluorinated ethers, which may be included in organosulfur-based electrolytes for purposes of reducing the viscosity thereof.

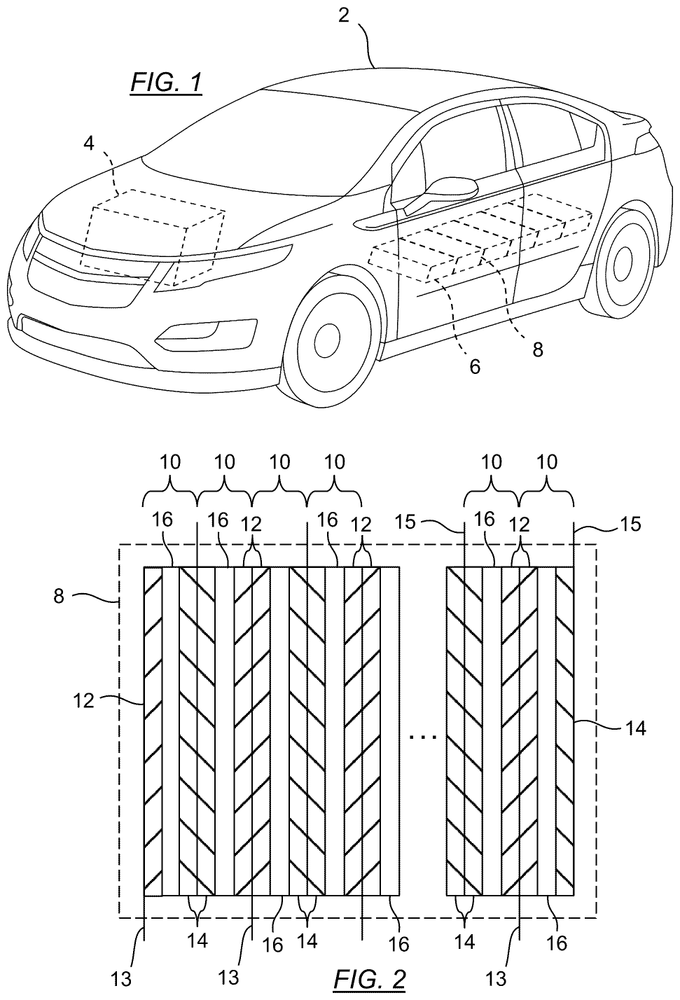

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. In practice, the separator layer 16 may be infiltrated with an electrolyte that provides a medium for the conduction of lithium ions between the negative electrode layer 12 and the positive electrode layer 14, or the separator layer 16 itself may function as an electrolyte. The negative electrode layers 12 are disposed on and in electrical communication with the negative electrode current collectors 13 and the positive electrode layers 14 are disposed on and in electrical communication with the positive electrode current collectors 15. As shown in FIG. 2, for efficiency, the layers may be stacked such that some of the negative electrode current collectors 13 and some of the positive electrode current collectors 15 are double sided and respectively include negative electrode layers 12 or positive electrode layers 14 on both sides thereof. In this arrangement, adjacent negative electrode layers 12 and positive electrode layers 14 respectively share a single negative electrode current collector 13 or a positive electrode current collector 15.

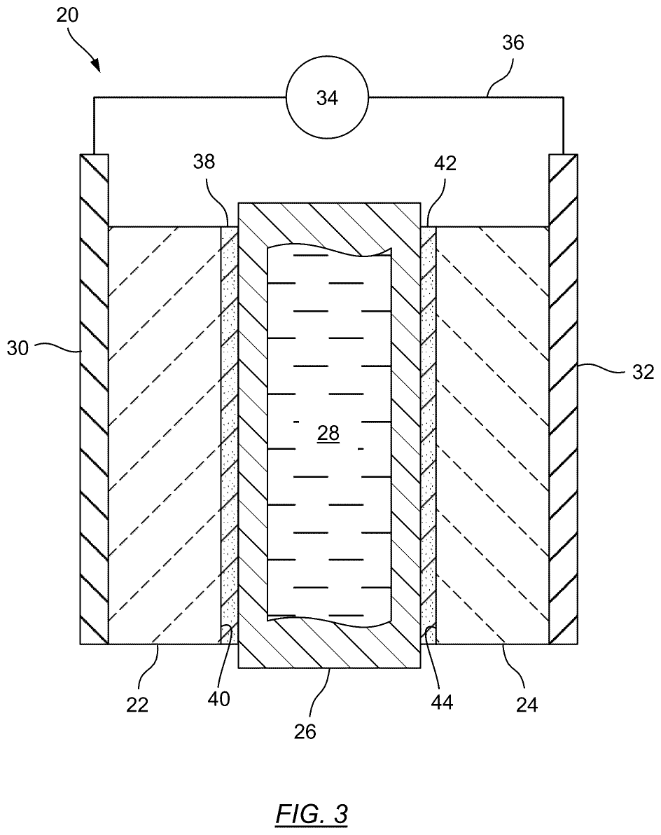

FIG. 3 depicts an electrochemical cell or battery 20 that cycles lithium ions. The battery 20 can generate an electric current during discharge, which may be used to supply power to a load device (e.g., the electric motor 4), and can be charged by being connected to a power source. Like the batteries 10 depicted in FIGS. 1 and 2, in aspects, the battery 20 may be used to supply power to the electric motor 4 of the automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, a separator 26, and an electrolyte 28 that provides a medium for conduction of lithium ions between the negative electrode 22 and the positive electrode 24. The negative electrode 22 is disposed on a major surface of a negative electrode current collector 30 and the positive electrode 24 is disposed on a major surface of a positive electrode current collector 32. In practice, the negative electrode current collector 30 and the positive electrode current collector 32 are electrically coupled to a power source or load 34 (e.g., the electric motor 4) via an external circuit 36. The negative electrode 22 and the positive electrode 24 are formulated such that, when the battery 20 is at least partially charged, an electrochemical potential difference is established between the negative electrode 22 and the positive electrode 24. During discharge of the battery 20, the electrochemical potential established between the negative electrode 22 and the positive electrode 24 drives spontaneous reduction and oxidation (redox) reactions within the battery 20 and the release of lithium ions and electrons from the negative electrode 22. The released lithium ions travel from the negative electrode 22 to the positive electrode 24 through the separator 26 and the electrolyte 28, while the electrons travel from the negative electrode 22 to the positive electrode 24 via the external circuit 36, which generates an electric current. After the negative electrode 22 has been partially or fully depleted of lithium, the battery 20 may be charged by connecting the negative electrode 22 and the positive electrode 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

In embodiments, after initial and/or repeated cycling of the battery 20, a first interphase layer 38 may form on surfaces 40 of the negative electrode 22 and a second interphase layer 42 may form on surfaces 44 of the positive electrode 24. The first and second interphase layers 38, 42 are electrically insulating and ionically conductive and, when present, are configured to help prevent undesirable chemical reactions from occurring between the electrolyte 28 and the respective negative and positive electrodes 22, 24 during cycling of the battery 20. In FIG. 3, the first interphase layer 38 is depicted as being disposed along an interface between the negative electrode 22 and the separator 26 and the second interphase layer 42 is depicted as being disposed along an interface between the positive electrode 24 and the separator 26; however, other arrangements are possible. For example, in aspects where the electroactive material of the negative electrode 22 and/or of the positive electrode 24 is in the form of a particulate material, the first interphase layer 38 may be disposed on surfaces of the electroactive material particles of the negative electrode 22 and/or the second interphase layer 42 may be disposed on surfaces of the electroactive material particles of the positive electrode 24. In such case, the first interphase layer 38 may extend at least partway into the negative electrode 22 (toward the negative electrode current collector 30) and/or the second interphase layer 42 may extend at least partway into the positive electrode 24 (toward the positive electrode current collector 32).

The negative electrode 22 is formulated to store and release lithium ions to facilitate charge and discharge, respectively, of the battery 20 and may be in the form of a continuous layer of material disposed on a major surface of the negative electrode current collector 30. The negative electrode 22 comprises an electrochemically active (electroactive) material (electroactive negative electrode material) that can store and release lithium ions by undergoing a reversible redox reaction with lithium during charge and discharge of the battery 20. Examples of electroactive negative electrode materials include lithium, lithium-based materials (e.g., alloys of lithium and silicon, aluminum, indium, and/or tin), carbon-based materials (e.g., graphite, activated carbon, carbon black, hard carbon, soft carbon, and/or graphene), silicon, silicon-based materials (e.g., alloys of silicon and lithium, tin, iron, aluminum, and/or cobalt), silicon oxide, silicon oxide-based materials (e.g., lithium silicon oxide), tin oxide, aluminum, indium, zinc, germanium, titanium oxide, lithium titanate, and combinations thereof. In embodiments, the electroactive material of the negative electrode 22 may comprise graphite, silicon, silicon oxide, or a combination thereof.

In embodiments, the negative electrode 22 may be porous and the electroactive material of the negative electrode 22 may be a particulate material. In embodiments where the electroactive material of the negative electrode 22 is a particulate material, particles of the electroactive material of the negative electrode 22 may be intermingled with a polymer binder and optionally an electrically conductive material. The polymer binder is electrochemically inactive and may provide the negative electrode 22 with structural integrity. Examples of polymer binders include polyvinylidene fluoride (PVDF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. The electrically conductive material is electrochemically inactive and may provide the negative electrode 22 with good electrical conductivity. Examples of electrically conductive materials include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole.

In other embodiments, the electroactive material of the negative electrode 22 may consist of lithium and the negative electrode 22 may be in the form of a nonporous metal film or foil, such as a lithium metal film or lithium metal foil. In such case, the negative electrode 22 may comprise, by weight, greater than 97% lithium, or optionally greater than 99% lithium. In embodiments where the electroactive material of the negative electrode 22 consists of lithium, the negative electrode 22 may be substantially free of elements or compounds that undergo a reversible redox reaction with lithium during operation of the battery 20. In addition, in such embodiments, the negative electrode 22 may be substantially free of a polymer binder.

The positive electrode 24 is formulated to store and release lithium ions during discharge and charge of the battery 20. The positive electrode 24 may be in the form of a continuous porous layer disposed on the major surface of the positive electrode current collector 32. The positive electrode 24 comprises an electrochemically active (electroactive) material (electroactive positive electrode material), a polymer binder, and optionally an electrically conductive material. In aspects, the electroactive material of the positive electrode 24 may be a particulate material and particles of the electroactive material of the positive electrode 24 may be intermingled with the polymer binder and the optional electrically conductive material. The same polymer binders and/or electrically conductive materials disclosed above with respect to the negative electrode 22 may be used in the positive electrode 24 for substantially the same reasons.

The electroactive material of the positive electrode 24 can store and release lithium ions by undergoing a reversible redox reaction with lithium at a higher electrochemical potential than the electroactive material of the negative electrode 22 such that an electrochemical potential difference exists between the negative electrode 22 and the positive electrode 24. The electroactive material of the positive electrode 24 may comprise a material that can undergo lithium intercalation and deintercalation or a material that can undergo a conversion reaction with lithium. In aspects where the electroactive material of the positive electrode 24 comprises an intercalation host material that can undergo the reversible insertion or intercalation of lithium ions, the electroactive material of the positive electrode 24 may comprise a lithium transition metal oxide. For example, the electroactive material of the positive electrode 24 may comprise a layered lithium transition metal oxide represented by the formula LiMeO₂ and/or Li₂MeO₃, a layered lithium-rich transition metal oxide represented by the formula Li₁₊ₓMe₁₋ₓO₂ (where 0<x≤0.33), an olivine-type lithium transition metal oxide represented by the formula LiMePO₄, a monoclinic-type lithium transition metal oxide represented by the formula Li₃Me₂(PO₄)₃, a spinel-type lithium transition metal oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). The electroactive material of the positive electrode 24 may constitute, by weight, greater than or equal to 80%, optionally 90%, optionally 95% to less than or equal to 99%, or optionally 98% of the positive electrode 24.

In embodiments, the electroactive material of the positive electrode 24 may comprise a material that is formulated to operate at relatively high-voltages, e.g., greater than or equal to 4.5 V vs. Li⁺/Li. Such electroactive materials may be referred to as “high-voltage positive electrode materials.” For example, in aspects, the electroactive material of the positive electrode 24 may comprise a layered lithium manganese-rich transition metal oxide represented by the formula LiMeO₂ and/or Li₂MeO₃, where Me comprises, by weight, greater than or equal to 50% manganese (Mn). In aspects, the electroactive material of the positive electrode 24 may comprise a layered lithium- and manganese-rich transition metal oxide represented by the formula Li₁₊ₓMe₁₋ₓO₂ (where 0<x≤0.33), where Me comprises, by weight, greater than or equal to 50% manganese (Mn). In some aspects, the electroactive material of the positive electrode 24 may comprise a layered lithium- and manganese-rich oxide represented by the formula Li₂MnO₃. In aspects, the electroactive material of the positive electrode 24 may comprise a layered lithium nickel-rich transition metal oxide represented by the formula LiMeO₂ and/or Li₂MeO₃, where Me comprises, by weight, greater than or equal to 50% nickel (Ni) (e.g., LiNi_{0.8}Mn_{0.1}Co_{0.1}O₂, NMC811). In aspects, the electroactive material of the positive electrode 24 may comprise a layered lithium- and nickel-rich transition metal oxide represented by the formula Li₁₊ₓMe₁₋ₓO₂ (where 0<x≤0.33), where Me comprises, by weight, greater than or equal to 50% nickel (Ni). In aspects, the electroactive material of the positive electrode 24 may comprise lithium manganese iron phosphate (LMFP), lithium iron phosphate (LFP), spinel lithium manganese oxide (LiMn₂O₄, LMO), high voltage spinel (LiNi_{0.5}Mn_{1.5}O₄, LNMO), lithium nickel cobalt manganese aluminum oxide (NCMA), lithium nickel manganese cobalt oxide (NMC), lithium nickel manganese oxide (LNMO), e.g., LiNi_{0.5}Mn_{1.5}O₄ and/or Li_{1.2}Ni_{0.2}Mn_{0.6}O₂, lithium nickel cobalt aluminum oxide (NCA), or a combination thereof.

The separator 26 physically separates and electrically isolates the negative electrode 22 and the positive electrode 24 from each other while permitting lithium ions to pass therethrough. The separator 26 has an open microporous structure and may comprise an organic and/or inorganic material. For example, the separator 26 may comprise a polymer. Examples of polymers for the separator 26 include polyolefins (e.g., polyethylene, PE, and/or polypropylene, PP), polyamide (PA), poly(tetrafluoroethylene) (PTFE), polyvinylidene fluoride (PVDF), poly(vinyl chloride) (PVC), and combinations thereof.

The electrolyte 28 is ionically conductive and provides a medium for the conduction of lithium ions between the negative electrode 22 and the positive electrode 24. The electrolyte 28 comprises an organosulfur compound, a fluorinated aromatic co-solvent, a solid electrolyte interphase (SEI) former, and a lithium salt. In embodiments, the electrolyte 28 may be an organosulfur-based electrolyte, meaning that the organosulfur compound is the single largest constituent of the electrolyte 28.

At a temperature of 10 degrees Celsius (° C.), the electrolyte 28 may have an ionic conductivity of greater than 3 millisiemens per centimeter (mS/cm) and a viscosity of less than 20 centipoise (cP). At a temperature of 25° C., the electrolyte 28 may have an ionic conductivity of greater than 4.5 mS/cm and a viscosity of less than 12 cP.

The organosulfur compound is formulated to function as a solvent to help solvate the lithium salt in the electrolyte 28. In addition, the organosulfur compound is formulated to provide the electrolyte 28 with good thermal stability and a wide electrochemical stability window, particularly high anodic stability (i.e., oxidative stability), even when the battery 20 is operating at high voltages of 4.5 V versus Li⁺/Li. The organosulfur compound may comprise a sulfoxide including a sulfinyl moiety (—S(═O)—), a sulfone including a sulfonyl moiety (—S(═O)₂—), or a combination thereof.

In embodiments, the organosulfur compound may comprise an acyclic sulfoxide represented by formula (1):

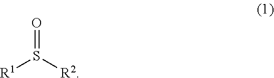

In the sulfoxide of formula (1), R¹ and R² are each individually H; halogen (e.g., F, Cl, Br, or I); an unsubstituted or fluorinated alkyl, alkenyl, alkynyl, silyl, siloxy, aryl, aralkyl, heterocyclyl, heterocyclylalkyl, cycloalkyl, or cycloalkylalkyl; —OR³; —C(O)R³; —C(O)OR³; or —OC(O)R³, where R³ is H or an unsubstituted or fluorinated alkyl, alkenyl, alkynyl, aryl, aralkyl, or heterocyclyl.

In embodiments, the organosulfur compound may comprise a cyclic or acyclic sulfone represented by formula (2):

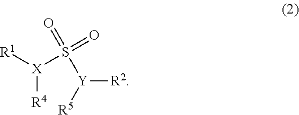

In the sulfone of formula (2), R⁴ and R⁵ are each individually H; halogen (e.g., F, Cl, Br, or I); an unsubstituted or fluorinated alkyl, alkenyl, alkynyl, silyl, siloxy, aryl, aralkyl, heterocyclyl, heterocyclylalkyl, cycloalkyl, or cycloalkylalkyl; —OR³; —C(O)R³; —C(O)OR³; or —OC(O)R³; or R⁴ and R⁵ can together form a 5 or 6 membered substituted or unsubstituted heterocyclic ring including the sulfur (S) atom. X and Y are each individually —C(R³)—, —O—, or —N—. In the sulfone of formula (2), R¹, R², and R³ are the same as defined above with respect to the sulfoxide of formula (1).

Cyclic or acyclic sulfones of formula (2), in which X is —C(R³)— or —N— and Y is —O—, may be referred to as cyclic or acyclic substituted or unsubstituted sulfonate esters. Cyclic or acyclic sulfones of formula (2), in which X is —C(R³)— or —N— and Y is —N—, may be referred to as cyclic or acyclic substituted or unsubstituted sulfonamides. Cyclic or acyclic sulfones of formula (2), in which X is —O— and Y is —O—, may be referred to as cyclic or acyclic substituted or unsubstituted sulfates.

In embodiments, the sulfone of formula (2) may be an acyclic sulfone. Examples of acyclic sulfones of formula (2) include ethyl methyl sulfone (EMS), dimethylmethanesulfonamide (DMMA), methyl isopropyl sulfone (MIS), dimethyl sulfate (DMS), methyl methanesulfonate (MMS), methanesulfonyl fluoride (MSF), and combinations thereof. In embodiments, the organosulfur compound may comprise EMS.

In embodiments where R⁴ and R⁵ in the sulfone of formula (2) form a 5 or 6 membered substituted or unsubstituted heterocyclic ring, the sulfone of formula (2) is a cyclic sulfone. Examples of cyclic sulfones of formula (3) include tetramethylene sulfone (TMS or sulfolane), cyclic sulfonate esters, known as sultones (e.g., 1,3-propane sultone), and combinations thereof.

The organosulfur compound may constitute, by weight or volume, greater than 5%, optionally greater than or equal to 10%, optionally greater than or equal to 20%, optionally greater than or equal to 30%, optionally greater than or equal to 40%, and less than or equal to 90%, optionally less than or equal to 80%, optionally less than or equal to 70%, optionally less than or equal to 60%, or optionally less than or equal to 50% of the electrolyte 28. In embodiments, the organosulfur compound may constitute, by weight or volume, greater than or equal to 40% and less than or equal to 60% of the electrolyte 28. For example, in embodiments, the organosulfur compound may constitute, by weight or volume, about 50% of the electrolyte 28.

The fluorinated aromatic co-solvent is formulated to provide the electrolyte 28 with good electrochemical stability at high operating potentials (e.g., greater than or equal to 4.5 V vs. Li⁺/Li), relatively low viscosity, and relatively high ionic conductivity, as compared to electrolytes that include fluorinated ethers as co-solvents in combination with organosulfur compounds as solvents. In addition, by helping to reduce the viscosity of the electrolyte 28, the fluorinated aromatic co-solvent may help improve the ability of the electrolyte 28 to wet the surfaces of and impregnate the open pores of the separator 26. The fluorinated aromatic co-solvent comprises a fluoroalkyl-substituted benzene, a fluoroalkoxy-substituted benzene, or a combination thereof. For example, the fluorinated aromatic co-solvent may comprise a mono-, di-, tri-, tetra-, penta-, or hexa-substituted fluoroalkyl benzene; a mono-, di-, tri-, tetra-, penta-, or hexa-substituted fluoroalkoxy benzene; or a combination thereof.

In particular, the fluorinated aromatic co-solvent comprises an aromatic hydrocarbon represented by formula (3):

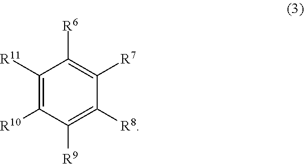

In the aromatic hydrocarbon of formula (3), R⁶, R⁷, R⁸, R⁹, R¹⁰, and R¹¹ are each individually H, halogen (e.g., F, Cl, Br, or I), alkyl, alkenyl (e.g., vinyl), alkynyl (e.g., propargyl), aryl (e.g., benzyl), alkoxy (e.g., methoxy), alkenoxy, alkynoxy, aryloxy, heterocyclyloxy, alkyl-heterocyclyloxy, hydroxyl (—OH), carboxyl (—COOH), ester (—COOR), or ether (—OR), where R is a hydrocarbon moiety as disclosed herein, and at least one of R⁶, R⁷, R⁸, R⁹, R¹⁰, and R¹¹ is a fluoroalkyl or a fluoroalkoxy, the fluoroalkyl having the formula —CₙHₓF_{y} or —CH₂CₙHₓF_{y} and the fluoroalkoxy having the formula —CH₂OCₙHₓF_{y} or —CF₂OCₙHₓF_{y}, where n is an integer from 1 to 5, x is an integer from 0 to 11, y is an integer from 1 to 11, and the sum of x and y is 2n+1.

The fluorinated aromatic co-solvent may constitute, by weight or volume, greater than 5%, optionally greater than or equal to 10%, optionally greater than or equal to 20%, optionally greater than or equal to 30%, optionally greater than or equal to 40%, and less than or equal to 90%, optionally less than or equal to 80%, optionally less than or equal to 70%, optionally less than or equal to 60%, or optionally less than or equal to 50% of the electrolyte 28. In embodiments, the fluorinated aromatic co-solvent may constitute, by weight or volume, greater than or equal to 20% and less than or equal to 40% of the electrolyte 28. For example, in embodiments, the fluorinated aromatic co-solvent may constitute, by weight or volume, about 30% of the electrolyte 28.

The SEI former is formulated to react with the electroactive material of the negative electrode 22 to help form the first interphase layer 38 on the surfaces 40 of the negative electrode 22. In embodiments, the SEI former may be formulated to react with the electroactive material of the positive electrode 24 to help form the second interphase layer 42 on the surfaces 44 of the positive electrode 24. The SEI former may comprise a cyclic carbonate selected from the group consisting of ethylene carbonate (EC), fluoroethylene carbonate (FEC), vinylene carbonate (VC), and vinyl ethylene carbonate (VEC). In embodiments, the SEI former may comprise FEC. The SEI former may constitute, by weight or volume, greater than 5%, optionally greater than or equal to 10%, optionally greater than or equal to 20%, optionally greater than or equal to 30%, optionally greater than or equal to 40%, and less than or equal to 80%, optionally less than or equal to 70%, optionally less than or equal to 60%, or optionally less than or equal to 50% of the electrolyte 28. In embodiments, the SEI former may constitute, by weight or volume, greater than or equal to 10% and less than or equal to 30% of the electrolyte 28. For example, in embodiments, the SEI former may constitute, by weight or volume, about 20% of the electrolyte 28.

The lithium salt is soluble in the organosulfur solvent and provides a passage for lithium ions through the electrolyte 28. The lithium salt may comprise an inorganic lithium salt, an organic lithium salt, or a combination thereof. Examples of inorganic lithium salts include lithium hexafluorophosphate (LiPF₆), lithium difluorophosphate (LiPO₂F₂), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiFSI), lithium bis(trifluoromethanesulfonyl)imide (LiTFSI), lithium tetraphenylborate (LiB(C₆H₅)₄), lithium bis(oxalato)borate (LiB(C₂O₄)₂) (LiBOB), lithium difluoro(oxalato)borate (LiBF₂(C₂O₄)) (LiDFOB), and combinations thereof. In embodiments, the lithium salt may comprise LiPF₆, LiFSI, LITFSI, or a combination thereof. The lithium salt may be present in the electrolyte 28 at a concentration of greater than or equal to 0.5 Molar (M), optionally greater than or equal to 1 M, and less than or equal to 2 M, or optionally less than or equal to 1.5 M. In embodiments, the lithium salt may be present in the electrolyte 28 at a concentration of 1.2 M. The lithium salt may constitute, by weight, greater than or equal to 5%, optionally greater than or equal to 10%, and less than or equal to 20%, or optionally less than or equal to 15% of the electrolyte 28.

In embodiments, the electrolyte 28 may be substantially free of acyclic fluorinated ethers. In particular, in embodiments, the electrolyte 28 may be substantially free of acyclic hydrofluoroethers, i.e., acyclic hydrofluorocarbon compounds having an ether moiety (R—O—R′, where R and R′ are polyfluorinated hydrocarbon moieties). For example, the electrolyte 28 may be substantially free of 1,1,2,2-tetrafluoro-1-(2,2,2-trifluoroethoxy)ethane, tris(2,2,2-trifluoroethyl)orthoformate, bis(2,2,2-trifluoroethyl) ether, 1,1,2,2-tetrafluoroethyl-2,2,3,3-tetrafluoropropylether, 1-ethoxy-1,1,2,2-tetrafluoroethane, and combinations thereof.

The negative electrode current collector 30 and the positive electrode current collector 32 are electrically conductive and provide an electrical connection between the external circuit 36 and the negative electrode 22 and the positive electrode 24, respectively. In aspects, the negative electrode current collector 30 and the positive electrode current collector 32 may be made of metal and may be in the form of nonporous metal foils, perforated metal foils, porous metal meshes, or a combination thereof. The negative electrode current collector 30 may be made of copper, nickel, or alloys thereof, stainless steel, or other appropriate electrically conductive material. The positive electrode current collector 32 may be made of aluminum (AI) or another appropriate electrically conductive material.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive.

What is claimed is:

1. A battery that cycles lithium ions, the battery comprising:
a negative electrode comprising an electroactive negative electrode material;
a positive electrode spaced apart from the negative electrode and comprising a high-voltage positive electrode material; and
an electrolyte infiltrating the positive electrode, the electrolyte comprising: an organosulfur compound, a fluorinated aromatic co-solvent, a solid electrolyte interphase (SEI) former, and at least one lithium salt.

2. The battery of claim 1, wherein the fluorinated aromatic co-solvent comprises a fluoroalkyl-substituted benzene, a fluoroalkoxy-substituted benzene, or a combination thereof.

3. The battery of claim 1, wherein the fluorinated aromatic co-solvent comprises an aromatic hydrocarbon represented by formula (3): 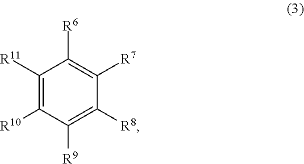
wherein:
R⁶, R⁷, R⁸, R⁹, R¹⁰, and R¹¹ are each individually H, halogen, alkyl, alkenyl, alkynyl, aryl, alkoxy, alkenoxy, alkynoxy, aryloxy, heterocyclyloxy, alkyl-heterocyclyloxy, hydroxyl, carboxyl, ester, or ether, and
at least one of R⁶, R⁷, R⁸, R⁹, R¹⁰, and R¹¹ is a fluoroalkyl or a fluoroalkoxy, the fluoroalkyl having the formula —CₙHₓF_{y} or —CH₂CₙHₓF_{y}, and the fluoroalkoxy having the formula —CH₂OCₙHₓF_{y} or —CF₂OCₙHₓF_{y}, where n is an integer from 1 to 5, x is an integer from 0 to 11, y is an integer from 1 to 11, and the sum of x and y is 2n+1.

4. The battery of claim 1, wherein the fluorinated aromatic co-solvent constitutes, by volume, greater than or equal to 10% and less than or equal to 90% of the electrolyte.

5. The battery of claim 1, wherein the organosulfur compound comprises an acyclic sulfoxide represented by formula (1): 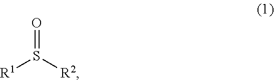
wherein:
R¹ and R² are each individually H; halogen; an unsubstituted or fluorinated alkyl, alkenyl, alkynyl, silyl, siloxy, aryl, aralkyl, heterocyclyl, heterocyclylalkyl, cycloalkyl, or cycloalkylalkyl; —OR³; —C(O)R³; —C(O)OR³; or —OC(O)R³; and
R³ is H or an unsubstituted or fluorinated alkyl, alkenyl, alkynyl, aryl, aralkyl, or heterocyclyl.

6. The battery of claim 1, wherein the organosulfur compound comprises a cyclic or acyclic sulfone represented by formula (2): 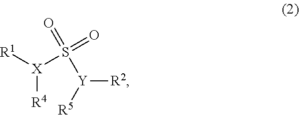
wherein:
R¹ and R² are each individually H; halogen; an unsubstituted or fluorinated alkyl, alkenyl, alkynyl, silyl, siloxy, aryl, aralkyl, heterocyclyl, heterocyclylalkyl, cycloalkyl, or cycloalkylalkyl; —OR³; —C(O)R³; —C(O)OR³; or —OC(O)R³;
R⁴ and R⁵ are each individually H; halogen; an unsubstituted or fluorinated alkyl, alkenyl, alkynyl, silyl, siloxy, aryl, aralkyl, heterocyclyl, heterocyclylalkyl, cycloalkyl, or cycloalkylalkyl; —OR³; —C(O)R³; —C(O)OR³; or —OC(O)R³; or R⁴ and R⁵ together form a 5 or 6 membered substituted or unsubstituted heterocyclic ring including the sulfur (S) atom;
X and Y are each individually —C(R³)—, —O—, or —N—; and
R³ is H or an unsubstituted or fluorinated alkyl, alkenyl, alkynyl, aryl, aralkyl, or heterocyclyl.

7. The battery of claim 1, wherein the organosulfur compound comprises an acyclic sulfone selected from the group consisting of ethyl methyl sulfone (EMS), dimethylmethanesulfonamide (DMMA), methyl isopropyl sulfone (MIS), dimethyl sulfate (DMS), methyl methanesulfonate (MMS), and methanesulfonyl fluoride (MSF).

8. The battery of claim 1, wherein the organosulfur compound comprises a cyclic sulfone selected from the group consisting of sulfolane and 1,3-propane sultone.

9. The battery of claim 1, wherein the organosulfur compound constitutes, by volume, greater than or equal to 10% and less than or equal to 90% of the electrolyte.

10. The battery of claim 1, wherein the SEI former comprises a cyclic carbonate selected from the group consisting of ethylene carbonate (EC), fluoroethylene carbonate (FEC), vinylene carbonate (VC), and vinyl ethylene carbonate (VEC).

11. The battery of claim 1, wherein the SEI former constitutes, by volume, greater than or equal to 5% and less than or equal to 50% of the electrolyte.

12. The battery of claim 1, wherein the at least one lithium salt comprises lithium hexafluorophosphate (LiPF₆), lithium bis(fluorosulfonyl)imide (LiFSI), lithium bis(trifluoromethanesulfonyl)imide (LiTFSI), or a combination thereof.

13. The battery of claim 1, wherein the at least one lithium salt is present in the electrolyte at a concentration of greater than or equal to 0.5 Molar and less than or equal to 2 Molar.

14. The battery of claim 1, wherein the electrolyte is substantially free of acyclic hydrofluoroethers.

15. The battery of claim 1, wherein the electroactive negative electrode material comprises graphite, silicon, silicon oxide, or an elemental lithium metal film.

16. A battery that cycles lithium ions, the battery comprising:
a negative electrode comprising an electroactive negative electrode material comprising graphite;
a positive electrode spaced apart from the negative electrode and comprising a high-voltage positive electrode material; and
an organosulfur-based electrolyte infiltrating the negative electrode and the positive electrode, the organosulfur-based electrolyte comprising:
an organosulfur compound comprising an acyclic sulfoxide, an acyclic sulfone, a cyclic sulfone, or a combination thereof,
a fluorinated aromatic co-solvent comprising a fluoroalkyl-substituted benzene, a fluoroalkoxy-substituted benzene, or a combination thereof,
a solid electrolyte interphase (SEI) former, and
a lithium salt.

17. The battery of claim 16, wherein the organosulfur compound constitutes, by volume, greater than or equal to 10% and less than or equal to 90% of the organosulfur-based electrolyte.

18. The battery of claim 16, wherein the fluorinated aromatic co-solvent constitutes, by volume, greater than or equal to 10% and less than or equal to 90% of the organosulfur-based electrolyte.

19. The battery of claim 16, wherein the SEI former comprises a cyclic carbonate selected from the group consisting of ethylene carbonate (EC), fluoroethylene carbonate (FEC), vinylene carbonate (VC), and vinyl ethylene carbonate (VEC), and wherein the SEI former constitutes, by volume, greater than or equal to 5% and less than or equal to 50% of the organosulfur-based electrolyte.

20. The battery of claim 16, wherein the lithium salt comprises lithium hexafluorophosphate (LiPF₆), lithium bis(fluorosulfonyl)imide (LiFSI), lithium bis(trifluoromethanesulfonyl)imide (LiTFSI), or a combination thereof, and wherein the lithium salt is present in the organosulfur-based electrolyte at a concentration of greater than or equal to 0.5 Molar and less than or equal to 2 Molar.
